(19) United States
(12) Patent Application Publication
(10) Pub. No.: US 2014/0249737 A1
(43) Pub. Date: Sep. 4, 2014

(54) Unknown

(71) Applicant: THALES, Neuilly Sur Seine (FR)

(72) Inventors: Hugues MEUNIER, FROUZINS (FR); Benoît COUTURIER, GOYRANS (FR)

(21) Appl. No.: 14/175,678

(22) Filed: Feb. 7, 2014

(30) Foreign Application Priority Data
Feb. 8, 2013 (FR) 13 00276

(51) Int. Cl. G08G 5/04; G08G 5/06

(52) U.S. Cl. CPC G08G 5/04; G08G 5/06
USPC 701/120

(57) ABSTRACT

Extended and integrated aeronautical safety and surveillance system comprising first means adapted for preventing in-flight collisions between aircraft (“TCAS”) second means for carrying out a function from among the surveillance and air traffic control functions (“ADS-B”). The system also comprises third means for carrying out at least one function from among a set of ground movements assistance functions comprising in particular a function for displaying a map during the movement of an aircraft in an airport. Finally the system is characterized in that the first, second and third means are embedded on one and the same hardware platform.

The present invention relates to an airborne system on board an aircraft, highly integrated and encompassing all or part of the functions necessary to ensure the functions of Safety, Surveillance and situation awareness between the aircraft and its environment (the various other aircraft, the control center, etc.). These functions supported by this system are those carried out during the in-flight phases but also extended to those carried out during the ground taxiing phases.

The field to which the invention relates is therefore that of the equipment installed on board an aircraft in order to carry out the Safety, Surveillance, situation awareness and alert functions, whether in flight or on the ground.

Independent devices making it possible to carry out the various surveillance, situation awareness and alert functions, mainly for the in-flight phases, are known in the prior art.

Typically, independent systems exist, whose actual implementation aboard aircraft varies from one type of aircraft to another. These devices or systems are in particular the following:
A transponder which makes it possible to respond to the interrogations of the control centers to ensure the surveillance of the air traffic
A traffic alert and collision avoidance system (known also by the acronym “TCAS” for “Traffic Collision Avoidance System”) making it possible to provide the crew with a view (also known as situation awareness) on an onboard screen of the surrounding traffic around the aircraft and to generate at the level of the audio system and/or in a visual manner, on indicators or screens, appropriate alerts in the case of more or less substantiated risks of collision with other aircraft.
A system known by the acronym “TAWS” for “Terrain Awareness and Warning System” making it possible to provide the crew with a view of the situation on an onboard screen of the relief surrounding the aircraft and to generate at the level of the audio system and/or in a visual manner, on indicators or screens, appropriate alerts in the case of more or less substantiated risks of collision with the relief
A meteorological radar device (also known as a “weather radar”) making it possible to provide the crew with a view (situation awareness) on an onboard screen of the meteorological situation ahead of the aircraft and to generate at the level of the audio system and/or in a visual manner, on indicators or screens, appropriate alerts in the case of more or less substantiated risks of presence of meteorological phenomena.

Solutions where several of these independent devices are grouped into a single device so as to make it possible to reduce the weight and/or the volume of the whole are known in the prior art. Typically, these entail systems, described in the ARINC 768 standard, such as:
“T2CAS” for Terrain and Traffic Collision Avoidance System. “T2CAS” is the trade name (owned by the enterprise ACSS) given to the grouping of the “TCAS” and “TAWS” devices
“T3CAS” trade name (owned by the enterprise ACSS) given to the grouping of the “TCAS”, “TAWS” and “Transponder” devices. “T3CAS” signifies “Transponder, Traffic & Terrain Alerting system”.
“ISS” for “Integrated Surveillance System” corresponding to the grouping of the “TCAS”, “TAWS”, “Transponder” and “Weather radar” devices.

Moreover additional devices, also independent, exist for assisting the crew when the aircraft is in the midst of ground taxiing operations. Typically, the following additional devices exist, independently of the other systems mentioned hereinabove:
“Airport Navigation” offering ground movements assistance functions whose main function is to display on onboard screens a more or less simplified synthetic representation of all or part of the airport elements over which the crew must make the aircraft advance. This device also allows other functions making it possible to generate at the level of the audio system and/or in a visual manner, on indicators or screens, the following elements:
   appropriate alerts in the case of various more or less substantiated risks in relation to airport elements and/or collision with another aircraft.
   trajectory or guidance information.

Also known in the prior art are the NextGen and SESAR research research programs, which reveal other surveillance, situation awareness and alert functionalities but whose continued implementation is limited to the development or upgrading of independent equipment. Thus this implementation does not make it possible to obtain an optimized implementation.

Among these other operational capabilities or functionalities may be cited:
the “ADS-B out” (“Automatic dependent surveillance-broadcast”) functionality. This functionality is defined in the standards RTCA DO 260/260B which are known to the person skilled in the art and implemented at present with the “TCAS”, the whole being dubbed “Traffic Computer”
The “ADS-B in” and/or “TIS-B in” functionality such as defined in the standards RTCA DO 289 and DO 317A known to the person skilled in the art and implemented at present with the “Transponder”. The “TIS-B” function which allows the air traffic control to dispatch aboard aircraft the position of airplanes that are not equipped with the “ADS-B” functionality but are detected by the radars located on the ground.
The “ADS-B” applications, which are surveillance applications, that is to say applications allowing the air traffic control to ascertain the position of aircraft. These applications are defined on the basis of the “ADS-B in” functionality, in particular Applications known by the acronym “ATSAW” for “Airbone Traffic
   Situation Awareness”, allow the in-flight display on an onboard screen of the surrounding aircraft. This application is defined by the standards RTCA DO 289, D0317A, RTCA DO 289, DO 317 A, D0319, D0359 (“ATSA-AIRB” for “Air Traffic Situation Awareness—Airborne”), D0314 (“ATSA-VSA” for “Air Traffic Situation Awareness Visual Separation in Approach”) and D0312 (“ATSA-ITP”) and which are implemented at present in a “Traffic Computer”
   An “ATSA-SURF” (“Air Traffic Situation Awareness” on the airport surface) application, allowing the display when the aircraft is on the ground and on a screen located aboard the aircraft of the surrounding aircraft. This application is defined in the document RTCA D0322 and its implementation in current devices is variable according to aircraft.
The “Hybrid Surveillance” functionality defined in the standard RTCA D0300 and implementable in a “Traffic Computer”. This functionality is also known by the name “combined surveillance” (combination of the TCAS and ADS-B operations).

Other operational capabilities are known to the person skilled in the art, however the implementation of these capabilities is carried out in the form of independent devices that are scarcely integrated with the other devices mentioned hereinabove. These functionalities include among them in particular:
a functionality known by the acronym “SURF-IA” (for SURFace Indications and Alerts) and providing alerts in the case of risk of collision between aircraft on the surface of the airport and/or in flight. This functionality is defined in the document RTCA D0323, but its implementation is at present carried out only in a “Traffic Computer”.
a “D-TAXI” functionality making it possible to display the trajectory to be followed on the ground.

Other functionalities, more related to the improving of safety, are also known to the person skilled in the art, but here again in the form of independent devices which are scarcely integrated with the other devices mentioned hereinabove. These functionalities include among them in particular:
a functionality known by the name “Runway Overrun Awareness and Alerting”. This functionality makes it possible to provide the crew with a view on an onboard screen of the relative position of their own aircraft in relation to the end of runway that it is using and to generate at the level of the audio system and/or in a visual manner on indicators or screens appropriate alerts in the case of more or less substantiated risks of overrunning the runway end.

However, on account of this independence, the manner of operation of these devices does not allow certain optimizations beyond a simple physical grouping. In particular, this does not allow the pooling of the resources and/or of the various methods and logic implemented by these devices.

Stated otherwise and as indicated hereinabove, even if there exists in the prior state of the art groupings of certain devices, these groupings are mainly physical groupings with few functional interactions, the latter being limited globally to the pooling of the signals at the input and at the output of the various integrated devices.

Although the management of priority of the alerts between the various devices integrated into one and the same system is known in the prior art (see in particular the American patents reference U.S. Pat. No. 6,002,347 and U.S. Pat. No. 6,127,944), the possibility of grouping the already integrated devices with a device of “Airport Navigation” type, and of implementing other functions on this same platform so as to benefit from the resources implemented by the functions already existing on these platforms is not known in the prior state of the art. For example, it is not known to pool the images generated, the databases up until now specific to each application.

Conversely, the integration of a “weather radar” device introduces several installation constraints (installation of the radar antenna, waveguide, etc.) and does not introduce any synergy with the other integrated functionalities such as in “T2CAS” or “T3CAS”.

The great variety of these mutually incompatible, more or less globally integrated devices, does not allow the introduction of the new operational capabilities, described in the NextGen and SESAR research programs, in a single and homogeneous manner across the various aircraft. Thus, for the integration of these new operational capabilities, which are in particular required by the NextGen and SESAR programs, the installations must be adapted case by case and this involves lengthy and expensive implementations. This has a negative impact on the rollout of these programs. Moreover this makes it necessary for the crews to receive specific training individual to each of these various installations. This individuality of each installation, in particular of the interfaces with the crew, increases the risk of accidents, through lack of practice of each installation by the crew. Moreover, the databases not being shared collectively, risks of inconsistency may crop up during the use of these diverse devices.

The present invention is therefore aimed at remedying these problems by proposing a system making it possible to integrate broadly on one and the same hardware platform most of the functions necessary for the surveillance, situation awareness and alert functions, of an aircraft whether in flight or on the ground.

The present invention proposes a system comprising first means adapted for preventing in-flight collisions between aircraft (“TCAS”), second means for carrying out a function from among the surveillance and air traffic control functions (“ADS-B”), and third means for carrying out at least one other function from among the ground movements assistance functions, comprising in particular a function for displaying a map during the movement of an aircraft in an airport. The system is characterized in that the first, second and third means are embedded in one and the same hardware platform.

The system of the invention exhibits the following advantages:
It allows the use of the same hardware resources thereby allowing a reduction in the weight and volume of the system.
It allows rationalization of the information transmitted for visualization (same data transmission protocol, consistent and merged images).
It allows the use of common database shared by the various functions implemented on the platform: airport map movement function (or “Airport moving map”) and “ADS-B” I “ATSA-SURF” function.
It makes it possible to homogenize the image generated between the traffic and the airport map this makes it possible to limit the risks of inconsistencies.
It makes it possible to rationalize the installation of these various devices aboard the aircraft since now only a single item of equipment is needed.
It allows the use of the same aircraft position information for the whole set of functions. This rationalization of the location allows a reduction in the risks of inconsistencies between the various functions.

It enables the various other functionalities mentioned hereinabove to be added at lesser cost and easily, and makes it possible to benefit from the strong synergies exhibited by them with the basic functionalities. These synergies allow in particular the pooling of the position information, of the information about the other traffic, of the information about the airport, of the management of centralized alerts by way of a common database comprising the set of the alert messages, of the format of the data links used to dispatch the visualization information, the construction of consistent composite images as well as the various databases (such as airport elements, coordinates regarding navigation and/or airport, or indeed terrain, obstacles, etc.).

Stated otherwise it makes it possible to use one and the same processing platform (the processing platform comprises the processor the devices of collectively shared input/output type and the operating system), to perform in parallel the various envisaged applications.

The system also makes it possible to pool:
the processings for acquiring the parameters required by each of the functions implemented on this platform
the various databases used by these various functions
the access to a voice synthesizer to generate the various audible messages through these various functions
the processings for formatting (on the various possible bus types considered) of the outputs (audible and/or visual alarms and/or images and/or other information output by these processings) calculated by these various functions
the output of one or more audible and or visual alarms. A priority is associated with each output so as to the classes between them on the basis of those generated by these various functions.

Moreover the system makes it possible to render homogeneous the formation of “composite” images, that is to say images composed of elements generated in a consistent manner by these various functions.

Finally the system also makes it possible to select from among several possible outputs while adding a priority to each, the output used by one or more audible and or visual alarms. These alarms are ranked by mutual priority on the basis of the information obtained from the various functions.

This system makes it possible to choose parameters optimizing the various surveillance, situation awareness and alert functions whether in flight or on the ground to the constraints of the various players in the aeronautical world.

Advantageously the system furthermore comprises a database storing the information usable by the first, second and third means and means of access to said database. Moreover, the first, second and third means are adapted for accessing the information of said database by using said access means.

Advantageously the database and the access means are implemented in the hardware platform.

Advantageously the database and the access means are linked to the hardware platform by a wired link.

Advantageously the system furthermore comprises alerts emission means. Moreover, the first, second and third means are adapted for using the alerts emission means.

Advantageously the alerts emission means are implemented in the hardware platform.

Advantageously the alerts emission means are linked to the hardware platform by a wired link.

Advantageously the system furthermore comprises common display means. Moreover the first, second and third means are adapted for using the common display means.

Advantageously the common display means are implemented in the hardware platform.

Advantageously the common display means are linked to the hardware platform by a wired link.

Advantageously the system furthermore comprises means of location of the aircraft. Moreover the first, second and third means are adapted for using the location means.

Advantageously the location means are implemented in the hardware platform.

Advantageously the location means are linked to the hardware platform by a wired link.

Advantageously the system comprises in the same platform fourth means adapted for preventing an aircraft from coming into collision with the ground during a controlled flight phase (“TAWS”).

Advantageously, the system comprises in the same platform fifth means for carrying out at least one other function from among the “SURF-IA”, “D-TAXI” or “Runway Overrun Awareness and Alerting” function.

The invention will be better understood and other advantages will become apparent on reading the detailed description given by way of nonlimiting example and with the aid of the figures among which:

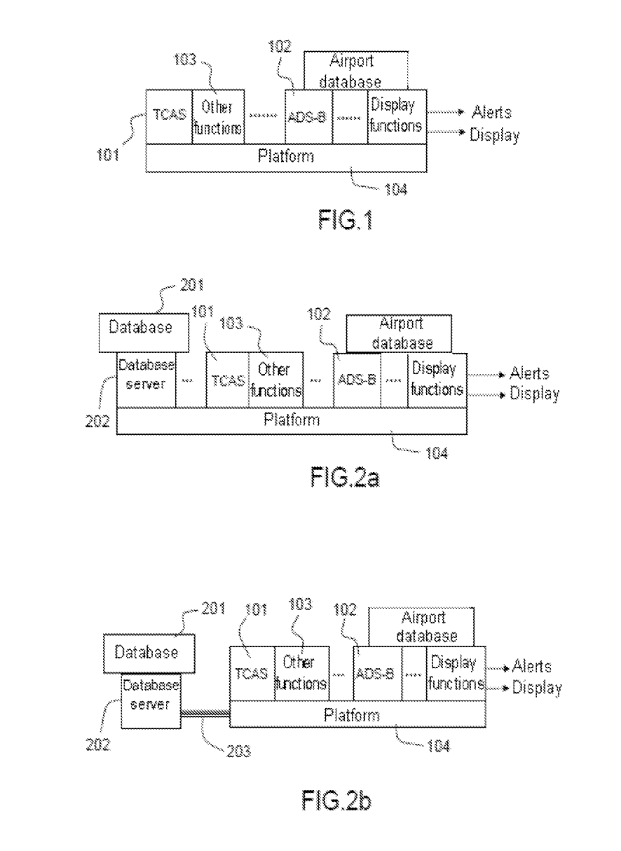

FIG. 1 presents the system according to a first aspect of the invention

FIG. 2.a presents the system, according to an embodiment, in the case where a common database is used

FIG. 2.b presents the system, according to another embodiment, in the case where a common database is used

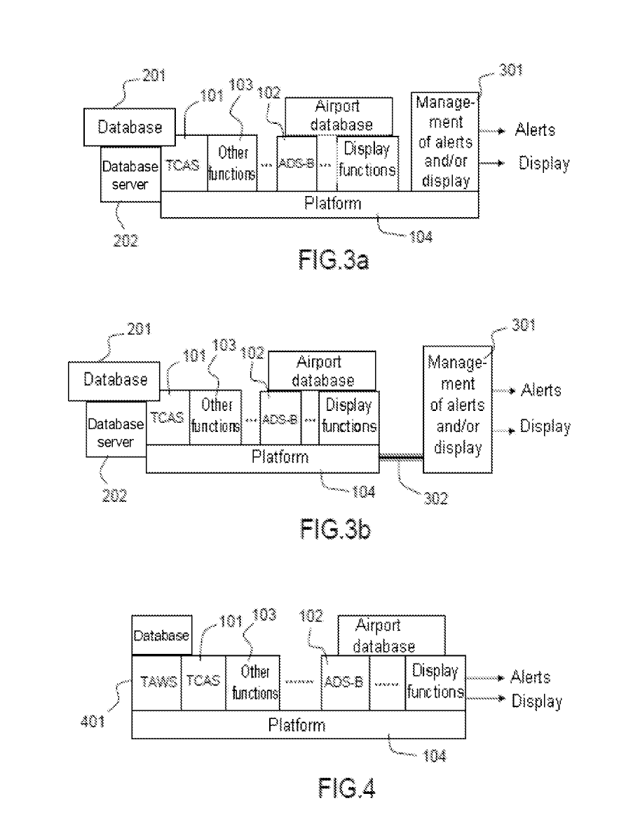

FIG. 3.a presents the system, according to an embodiment, in the case where a common device for managing the alerts and the display is used

FIG. 3.b presents the system, according to another embodiment, in the case where a common device for managing the alerts and the display is used

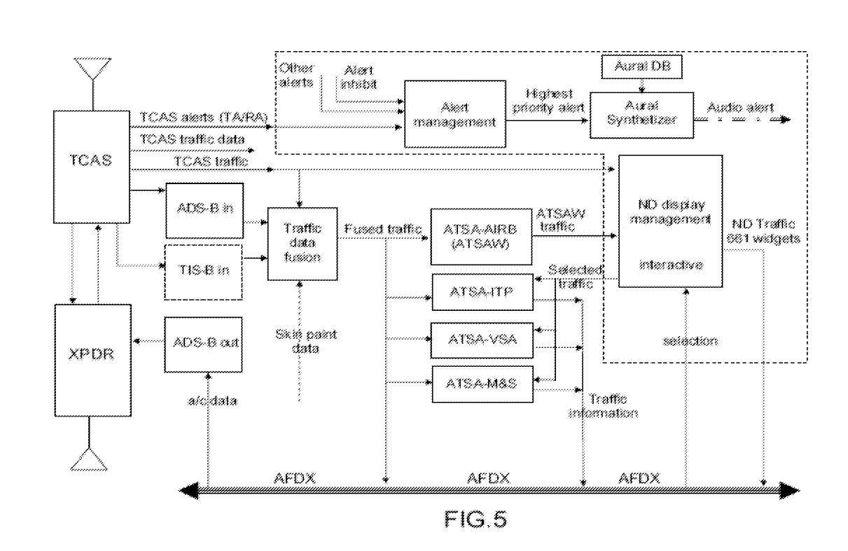

FIG. 4 presents the system, according to another embodiment, in which a device adapted for preventing an aircraft from coming into collision with the ground during a flight phase controlled by an air traffic controller (“TAWS”) is added

FIG. 5 presents the system according to another embodiment

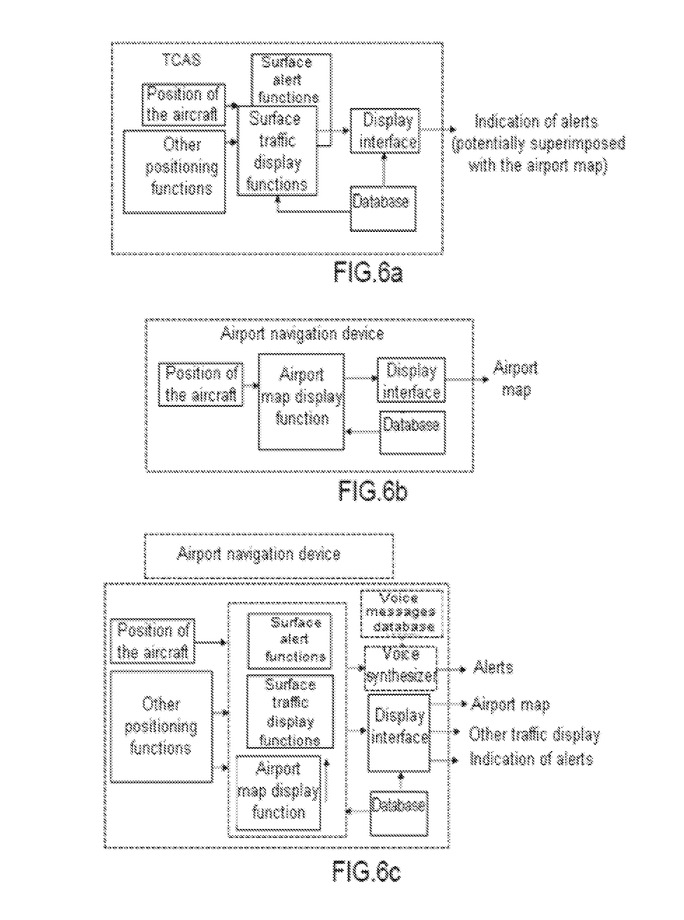

FIGS. 6.a, 6.b and 6.c present the pooling of the TCAS and airport navigation functions

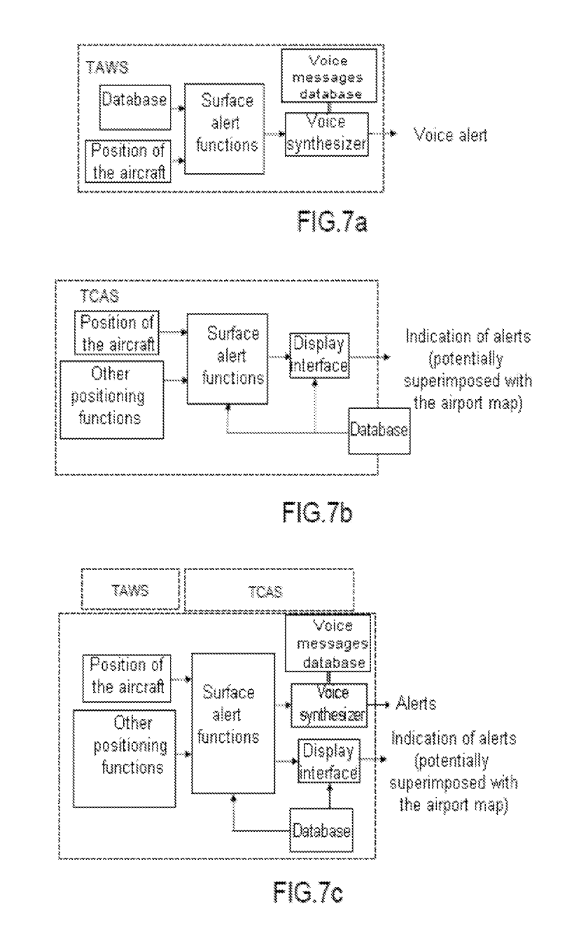

FIGS. 7.a, 7.b and 7.c present a first mode of pooling of the “TAWS” and “TCAS” functions.

FIG. 1 presents the system according to a first embodiment of the invention which integrates:
A first device 101 adapted for preventing in-flight collisions between aircraft (“TCAS”),
A second device 102 making it possible to carry out a function from among the surveillance and air traffic control functions (“ADS-B”),
A third device 103 for carrying out at least one other function from among the ground movements assistance functions comprising in particular a function for displaying a map during the movement of an aircraft in an airport.
These various devices are integrated on the same platform 104.

FIG. 2.a presents the system according to a second embodiment of the invention. In this embodiment, the system comprises a database 201 for common storage of the information usable by the various devices. In this embodiment, the system comprises a device 202 for access to this database. This database 201 and this access device 202 are implemented in the platform. FIG. 2.b exhibits an embodiment in which the database 201 and the access device 202 are implemented in a unit outside the system and linked by a wired link 203.

The database can comprise the following information:
Advantageously the information relating to the terrain of deployment of the aircraft, serving in particular a device making it possible to prevent an aircraft from coming into collision with the ground during a controlled flight phase. This information can also serve for display functions in two dimensions or three dimensions. This database is not useful in a basic version of the system, but becomes useful in the case where the “TAWS” function is also integrated onto the platform.
The information descriptive of the airport on which the aircraft is deploying, has taken off or will land. This information is used in particular by the “ADS-B”device, one of whose functions is to allow the display of the surrounding aircraft. This information is also used to display the airport map on an onboard screen. The information may be available at various resolutions so as to accommodate the needs of the various functions.

The various functionalities mentioned hereinabove require that the system comprises a device for location of the aircraft. The first, second and third devices are then adapted to use one and the same collectively shared location device. This location device relies for example on the information provided by a satellite location signals receiver, complying with the GNSS (“Global Navigation Satelite System”) standard based on one or more satellite positioning systems such as GPS “Global Positioning System) or such as Galileo. This location device can also be either complemented advantageously by the information provided by an inertial rig or a system known by the acronym AHRS for “Attitude and Heading Reference System”.

These location devices are generally implemented in a unit outside the system and linked by one or more wired (electrical or optical) links, but may also be implemented in the platform.

FIGS. 3.a and FIG. 3.b present the system according to another embodiment of the invention. In this embodiment the system also comprises a device 301 for emitting alerts which is common to the various devices. This device 301 allows the emission of audible messages stored in a database. This device 301 for emitting alerts can be implemented in the platform or be implemented in a unit outside the system and linked by a wired link 302.

Moreover this device 301 for emitting alerts can also make it possible to effect a common display. This device 301 makes it possible to merge the display of the information originating from the first, second and third devices. This device 301 can use the ρ, θ format, the X/Y format, the 429 format, the format according to ARINC standard 664 Part 7 (commonly called AFDX), the format according to ARINC standard 818 or the ASVI video format. The display device or devices are in general implemented as specific devices in the aircraft and are linked to the platform by one or more wired (electrical or optical) links 302, but may also be implemented in the platform.

In FIG. 3.a, the device for emitting alerts is implemented in the hardware platform, in FIG. 3.b, the device for emitting alerts is implemented in a unit outside the system. This external unit is linked by a wired link 302 with the hardware platform.

FIG. 4 presents the system according to another embodiment of the invention. In this embodiment a fourth device 401 is added. This fourth device is adapted for preventing an aircraft from coming into collision with the ground during a flight phase controlled by an air traffic controller (“TAWS”). This fourth device is embedded on the hardware platform 104.

Here the database represented comprises information relating to the terrain (in particular the relief), to the various runways of the airport and advantageously the climb performance of the aircraft. The database is therefore different from that pooled in common between “ADS-B” and the airport navigation function, also known as “Airport Navigation”.

FIG. 5 presents an embodiment in which the system makes it possible to carry out the following functions:
a “TCAS” function which by interferometry of signals emitted and received makes it possible to determine the angular position and the distance of the various traffic (other airplanes) around its airplane
an “ADS-B in” function, integrated into the “TCAS” function (for convenience, since it implements the same electronic circuits for signals reception), and making it possible to ascertain the geographical position of the various aircraft around the aircraft using the system (this function fulfills a role equivalent to that of the “TCAS” function).

This system also uses the knowledge of the various aircraft which surround the aircraft. This item of information is provided by the “ADS-B in” function and is optionally merged with the information representative of the various aircraft detected and which arises from the “TCAS” function (function also known in the prior art as “hybrid surveillance”), to carry out several functions of “ASAS” (“Airborne Separation Assurance System”) type. Among these functions are found in particular.
a “ATSA-AIRB” function making it possible to visualize the various traffic on a display screen.
functions of type “ATSA-VSA” or “ATSA-IM” (for Air Traffic Situation Awareness interval management” with functionality for aiding separation with other traffic/maintaining separation/managing the separation interval with the airplane ahead”) making it possible to select an aircraft in front of the aircraft and to maintain a minimum distance with this aircraft.
another “ATSA-SURF” function which just as for the “ATSA-AIRB” function makes it possible to visualize, on a display screen, the various surrounding aircraft on the surface of an aerodrome. These aircraft are displayed on an airport map, it therefore requires the use of an airport database, to allow the display of this airport map (this map is known in the prior art as a “moving map”).

In contradistinction to what is proposed by the prior art, where the airport map used for the “ATSA-SURF” function is different from that used by the airport navigation function, the invention such as presented in FIG. 5 proposes to pool the airport map used by the airport navigation function and that used by the “ATSA-SURF” function.

The other advantages of pooling the airport navigation function with the “ASAS” function, and by extension the “TCAS” function, and other surveillance functions such as the “TAWS” function, emerges from this pooling.

Indeed, the “ASAS” functions can thus benefit from the same hardware interfaces (video links and/or buses) as those used by the “Airport Navigation” function to display in a consistent manner the information the surrounding traffic and the associated possible alerts with the surrounding traffic and the possible alerts identified by the “TCAS” function. And more particularly for the “ATSA-SURF” function to display in a consistent manner the information the surrounding traffic and the associated possible alerts with the airport elements displayed for the “Airport Navigation” function.

Moreover the aim of the function known as “Indicating and Alerting” is to generate alerts when a risk exists of collision on the ground between various aircraft. This function uses the position information calculated by the “ADS-B in” function, in particular the position of the aircraft. Moreover the position of these aircraft and the and alerts are viewed on the airport map. This “Indicating & Alerting” function uses most particularly on the information on surrounding traffic transmitted by the “ADS-B in” function destined for the “ASAS” functions, to generate the appropriate alerts. The pooling of the function “Indication & Alerting” with the “ASAS” functions therefore makes it possible to generate alerts and the associated possible visualizations, consistent with those generated by the “ASAS” functions, and to benefit from the same audio messages generator as that used for the “TAWS” and “TCAS” functions available on the hardware platform encompassing the whole.

Likewise the function known as “ROP” “Runway Overrun Protection” (system for protecting against overrun of the runway threshold), allows an aircraft to generate alerts according to the envisaged landing distance in relation to the available runway length.

This function requires the determination of the most probable landing runway so as to determine therefrom its available distance (such a functionality is currently implemented in the “TAWS” function so as to inhibit the alerts managed by the “TAWS” function during a normal approach over a runway) and relies on a database known as “Runway” (this database comprises the characteristics of the runways of the various airports).

The system presented in FIG. 5 therefore allows a pooling between elements of the function known as “ROP” with the “TAWS” function. Moreover the result and the corresponding possible alerts, generated by the “ROP” function, are advantageously displayed on a display screen for the airport moving map.

This system also allows synergies between the “ROP” function and the “ATSA-SURF”, “Indicating and Alerting” and airport navigation function in particular the use for the audio alerts messages of the same voice synthesizer as for the “TCAS” and “TAWS” functions.

Indeed the “ROP” function can thus use the same runway information database as that used by the “TAWS”, use the same audio messages generator as that used for the “TAWS” and “TCAS” functions, use the same hardware interfaces (video links and/or buses) as those used for the “ATSA-SURF” and “Airport Navigation” function to display in a consistent manner the information and alerts of the “ROP” function with the airport elements displayed for the “Airport Navigation” function.

Likewise the “Indicating & Alerting” function can thus benefit from the same audio messages generator as that used for the “TAWS”, “TCAS” and “ROP” functions, use the same hardware interfaces (video links and/or buses) as those used by the “ATSA-SURF”, “Airport Navigation” and “ROP” function to display in a consistent manner the information and alerts of the “Indicating & Alerting” function with the airport elements displayed for the “Airport Navigation” function, and use the same information on the surrounding traffic as the “ADS-B in”, “TCAS” function, available on the hardware platform encompassing the whole.

FIG. 6.a presents another embodiment of the second device making it possible to prevent in-flight collisions between aircraft (“TCAS”). In this embodiment the device comprises:
A database of the runways of the airport
Functions for determining the position of the aircraft
Other positioning functions
Functions allowing the determination of a risk of collision between aircraft deploying on the ground
A display interface
A database of the airport elements
Means of display of the indications of the alerts. This indication of the alerts can be superimposed with the display of an airport map.
   Moreover the device comprises a surface traffic display function. This function allows the display of the information relating to the various aircraft taxiing in a given airport at a given instant.

FIG. 6.b presents an embodiment of a device making it possible to carry out an airport navigation management function. This device comprises in particular the following elements:
Functions for determining the position of the aircraft
Functions for displaying airport maps
A display interface
Means of display of the airport map
A database of the airport elements

It is therefore apparent that certain elements are conjoined with the “TCAS” device and with the device making it possible to carry out an airport navigation management function. In particular the following elements are present in both devices:
Functions for determining the position of the aircraft
A database of the airport elements
A display interface

It is therefore possible to pool some of these elements, if the second device (“TCAS”) and the device making it possible to carry out an airport navigation management function are implemented on one and the same hardware platform. An embodiment of this pooling is presented in FIG. 6.c.

FIGS. 7.a and 7.b present the functions contained in a first device making it possible to prevent an aircraft from coming into collision with the ground during a flight phase controlled by an operator on the ground (“TAWS”) and a second device making it possible to prevent in-flight collisions between aircraft (“TCAS”). The device of FIG. 7.a (“TAWS”) comprises:
A database comprising information relating to the terrain (in particular the relief), to the various runways of the airport and advantageously the climb performance of the aircraft.
Functions for determining the position of the aircraft
Functions allowing the determination of a risk of collision between aircraft deploying on the ground
A database of voice messages
A synthesizer of voice messages which, by virtue of the use of the database of voice messages, allows the emission of verbal messages.
A relief image and alerts generating device.

The device of FIG. 7.b (“TCAS”) comprises:
Functions for reception and interferometry of the responses of the various other aircraft making it possible to determine their relative positioning with the position of the aircraft
Functions allowing the determination of a risk of collision between aircraft deploying on the ground
A database of voice messages
A synthesizer of voice messages which, by virtue of the use of the database of voice messages, allows the emission of verbal messages.
A relief image and alerts generating device
An interface for displaying the surrounding aircraft be they in flight or on the airport surface
Means of display of the indications of the alerts. This indication of the alerts can be superimposed with the display of an airport map.
   It is therefore apparent that certain elements are conjoined with the “TAWS” device and with the “TCAS” device. In particular the following elements are present in both devices:
The functions for determining the position of the aircraft
The functions allowing the determination of a risk of collision between aircraft deploying on the ground
   It is therefore possible to pool some of these elements, if the first device (“TAWS”) and the second device (“TCAS)” are implemented on one and the same hardware platform. An embodiment of this pooling is presented in FIG. 7.c.

Moreover the ARINC standard 735 B presents a system known by the name “Traffic Computer”, and which in order to carry out the functions known by the acronym “ATSAW” comprises the following elements:
Functions for determining the position of the aircraft
A function of “ADS-B in” type
“ATSAW” functions for displaying the relative positioning of the various other aircraft with respect to the system carrier aircraft
Finally a database of the airport elements (these elements are used by the “ATSA-SURF” function).

Stated otherwise it is possible to have a consistent integration of certain elements of the devices having the function of displaying the surface indications with certain elements of the device having the function of displaying the alerts relating to the risk of collision between an aircraft and an element on the surface of the ground. This consistent integration relates in particular to the database representative of the airport elements. It is also possible to effect a consistent integration of the data representative of the location of the aircraft. This integration is achievable by implementing these elements on the hardware platform or on a system external to the hardware platform.

The indications and the alerts are those associated with the aircraft on which the system is installed. These indications and alerts relate to the position of the aircraft with respect to the various elements of the airport.

Likewise, it is possible to have a consistent integration of the display of the traffic on the surface of the airport, of the display of the alerts relating to the risk of collision between an aircraft and an element on the surface of the ground and of the display of the airport map. This is achieved by sharing the airport database. It is thus possible to effect a consistent integration or consistent common pooling, of the data representative of the location of the aircraft. This integration is achievable by implementing this function on the hardware platform or on a system external to the hardware platform.

Concerning the pooling of the databases it is possible to carry out the following poolings:
The pooling of the database of the elements of the terrain of “TAWS” type (with a variable resolution and whose precision depends on the airport or the geographical zone considered), for the applications using a “TAWS” functionality, with the database of the elements of the terrain exhibiting a high resolution, this database is used for display applications in two dimensions and display applications in three dimensions.

To carry out this pooling, it is possible to put in place an algorithm having the following steps:
the extraction of the elements the database of the elements of the terrain exhibiting a high resolution
use of a resolution conversion algorithm applied to the data
filling the database of the elements of the terrain of “TAWS” type (with a variable resolution and whose precision depends on the airport or the geographical zone considered) with the elements whose resolution has been converted.
   It is also possible to carry out the following pooling:
The pooling of the database comprising the map of the airport, on which the aircraft is deploying, in graphical format, with the database comprising the map of the airport, on which the aircraft is deploying, in digital format.

To carry out this pooling, it is possible to effect this pooling by considering that the functions of “TAWS” type and the alert functions use the airport database in place of the runways database, the latter database being customarily used for the functions of “TAWS” type.

Moreover as the airport database in high resolution type already comprises indications on the landing runways, it is possible to delete the database of the landing runways in high resolution. The latter database is used in particular for the functions of display of surface elements and alert functions (in particular the emission of an alert in the case of overrun of the runway threshold).

Stated otherwise it is possible to have a consistent integration of certain elements of the devices having the function of displaying the surface indications with certain elements of the device having the function of displaying the alerts relating to the risk of collision between an aircraft and an element on the surface of the ground. This consistent integration relates in particular to the database representative of the airport elements. It is also possible to effect a consistent integration of the data representative of the location of the aircraft. This integration is achievable by implementing these elements on the hardware platform or on a system external to the hardware platform.

The indications and the alerts are those associated with the aircraft on which the system is installed. These indications and alerts relate to the position of the aircraft with respect to the various elements of the airport.

Likewise, it is possible to have a consistent integration of the display of the traffic on the surface of the airport, of the display of the alerts relating to the risk of collision between an aircraft and an element on the surface of the ground and of the display of the airport map. This is achieved by sharing the airport database. It is thus possible to effect a consistent integration or consistent pooling, of the data representative of the location of the aircraft. This integration is achievable by implementing this function on the hardware platform or on a system external to the hardware platform.

Concerning the pooling of the databases it is possible to carry out the following poolings:
The pooling of the database of the elements of the terrain of “TAWS” type (with a variable resolution and whose precision depends on the airport or the geographical zone considered), for the applications using a “TAWS” functionality, with the database of the elements of the terrain exhibiting a high resolution, this database is used for display applications in two dimensions and display applications in three dimensions.

To carry out this pooling, it is possible to put in place an algorithm having the following steps:
the extraction of the elements the database of the elements of the terrain exhibiting a high resolution
use of a resolution conversion algorithm applied to the data
filling the database of the elements of the terrain of “TAWS” type (with a variable resolution and whose precision depends on the airport or the geographical zone considered) with the elements whose resolution has been converted.
   It is also possible to carry out the following pooling:
The pooling of the database comprising the map of the airport, on which the aircraft is deploying, in graphical format, with the database comprising the map of the airport, on which the aircraft is deploying, in digital format.

To carry out this pooling, it is possible to effect this pooling by considering that the functions of “TAWS” type and the alert functions use the airport database in place of the runways database, the latter database being customarily used for the functions of “TAWS” type.

Moreover as the airport database in high resolution type already comprises indications on the landing runways, it is possible to delete the database of the landing runways in high resolution. The latter database is used in particular for the functions of display of surface elements and alert functions (in particular the emission of an alert in the case of overrun of the runway threshold).

1. An extended and integrated aeronautical safety and surveillance system, comprising:
first means adapted for preventing in-flight collisions between aircraft (TCAS);
second means for carrying out a function from among the surveillance and air traffic control functions;
third means for carrying out at least one function from among a set of ground movements assistance functions comprising in particular:
a function for displaying a map during the movement of an aircraft in an airport;
wherein the first, second and third means are embedded on one and the same hardware platform.

2. The system according to claim 1 furthermore comprising;
a database storing the information usable by the first, second and third means and
means of access to said database, which are common to said first, second and third means.

3. The system according to claim 2 in which said database and said access means are implemented in said hardware platform.

4. The system according to claim 2 in which said database and said access means are linked to said hardware platform by communication means.

5. The system according to claim 1 furthermore comprising;
alerts emission means common to said first, second and third means.

6. The system according to claim 5 in which said alerts emission means are implemented in said hardware platform.

7. The system according to claim 6 in which said alerts emission means are linked to said hardware platform by communication means.

8. The system according to claim 1 furthermore comprising;
display means common to said first, second and third means.

9. The system according to claim 8 in which said common display means are implemented in said hardware platform.

10. The system according to claim 8 in which said common display means are linked to said hardware platform by communication means.

11. The system according to claim 1 furthermore comprising;
means of location of the aircraft which are common to said first, second and third means.

12. The system according to claim 11 in which said location means are implemented in said hardware platform.

13. The system according to claim 11 in which said location means are linked to said hardware platform by communication means.

14. The system according to claim 4 in the communication means are wired or wireless means.

15. The system according to claim 1 furthermore comprising fourth means adapted for preventing an aircraft from coming into collision with the ground during a flight phase controlled by an air traffic controller, said fourth means being embedded on said hardware platform.

16. The system according to claim 1 furthermore comprising fifth means for carrying out at least one other function from among the SURF-IA, D-TAXI or “Runway Overrun Awareness and Alerting” function, said fifth means being embedded on said hardware platform.
